(19) United States
(12) Patent Application Publication
(10) Pub. No.: US 2016/0195447 A1
(43) Pub. Date: Jul. 7, 2016

(54) METHOD FOR DETERMINING AIRCRAFT CENTER OF GRAVITY INDEPENDENT OF MEASURING AIRCRAFT TOTAL WEIGHT

(71) Applicant: C. Kirk Nance, Keller, TX (US)

(72) Inventor: C. Kirk Nance, Keller, TX (US)

(21) Appl. No.: 14/590,555

(22) Filed: Jan. 6, 2015

(51) Int. Cl. G01M 1/12; G01G 19/07; B64D 45/00

(52) U.S. Cl. CPC G01M 1/125; B64D 45/00; G01G 19/07

(57) ABSTRACT

A method for determining a Center of Gravity of an aircraft, which is independent of measuring the aircraft weight. The total aircraft weight is determined by a method independent of measuring the weight supported by the main landing gear struts. The weight supported by the nose landing gear strut is subsequently measured. The measured weight associated with nose landing gear is subtracted from the independently determined total aircraft weight, to determine a calculated weight supported by the combined main landing gear struts. The resulting determined weight supported by the combined main landing gear is compared to the independently determined total aircraft weight, and allows for determination of the aircraft Center of Gravity. Inversely the measured nose strut weight is compared to the total aircraft weight, and allows for determination of the aircraft Center of Gravity. Aircraft Center of Gravity is determined without the total aircraft weight being measured.

### BACKGROUND OF THE INVENTION

There are many critical aspects of an aircraft taking flight, which a commercial airline must resolve when determining if a departing aircraft is safe for take-off. Two of these factors are identifying the proper Weight and Center of Gravity for the aircraft. Hereinafter, aircraft “Center of Gravity” will be referred to as aircraft “CG.”

The Federal Aviation Administration (“FAA”) has published FAA-Advisory Circular AC20-161 defining requirements for onboard aircraft weight and balance systems used to “measure” the aircraft weight. Variations of onboard aircraft weighing systems basically convert the aircraft landing gear struts into scales. Prior art methods for converting aircraft landing gear struts into scales are well documented and reference may be made to United States patents:

| | |
|---|---|
| #3,513,300 - Elfenbein | #5,548,517 - Nance |
| #3,584,503 - Senour | #6,128,951 - Nance |
| #3,701,279 - Harris | #6,237,406 - Nance |
| #5,214,586 - Nance | #6,237,407 - Nance |
| #5,521,827 - Lindberg | #7,967,244 - Long |

The FAA has also published Advisory Circular AC120-27E defining requirements for an approved method to determine the aircraft weight by “calculations” which are independent of any requirement to measure of the aircraft total weight. The fully loaded weight of the aircraft is calculated by a process of compiling the weights of various payload items based upon FAA approved “designated” average weights, for the varying elements such as passengers, carry-on baggage, checked baggage, crew weight, cargo weight and the weight of fuel loaded; onto a previously measured empty aircraft weight. This method of calculating the aircraft weight based on the summing of the various elements loaded on to a pre-measured empty aircraft weight is often referred to as the Load Build-Up Method, hereinafter referred to as “LBUM”.

In spite of the prior art patents, no U.S. airlines currently use OnBoard aircraft Weight and Balance Systems (OBWBS), but instead all typically use the UBUM to deternnine aircraft weight.

A determination of the aircraft CG can be made from the calculations for the weight of each element of payload to an assigned and known location within the aircraft. Aircraft CG is a critical factor within an airline's Flight Operations Department. If the aircraft CG is too far aft and outside the aircraft's certified CG limits, the aircraft nose can rise uncontrollably during take-off, where the aircraft will become unstable, resulting in a stall and possible crash. Furthermore, fuel is the most costly item in an airline's annual expenses. Airline profit margins are slim at best, so any and all efforts must be used to reduce fuel consumption. The aircraft CG location affects the amount of engine power required to keep the aircraft aloft, and how much fuel the engines require to do so. If an aircraft is loaded with the CG positioned towards the forward limit of the aircraft's CG envelope, the pilot must add rear stabilizer trim for the nose-heavy aircraft. This additional rear stabilizer trim will increase the aerodynamic drag on the aircraft, thus consume more fuel. If an aircraft can be loaded with the aircraft CG positioned near the aft limit of the aircraft CG envelope, the aircraft will require less trim and be more fuel efficient.

Typical aircraft used in day-to-day airline operations are commonly supported by a plurality of compressible, telescopic landing gear struts. These landing gear struts contain pressurized hydraulic fluid and nitrogen gas. The weight of the aircraft rests upon and is supported by “pockets” of compressed nitrogen gas, within the landing gear struts. Aircraft weight supported by these pockets of gas is called the “sprung” weight. There is additional aircraft weight which is not identified by changes in landing gear strut pressure. This additional weight is associated with various landing gear components located below the pockets of compressed gas including such items as the landing gear wheels, tires, brakes, strut piston, and other lower landing gear components. Aircraft weight associated with these lower landing gear components located below the pockets of compressed gas is called the “unsprung” weight. Unsprung weight remains a relatively constant weight. Aircraft brake wear and tire wear result in a minimal and virtually insignificant amount of weight loss to the unsprung weight. The unsprung weight is added to the sprung weight, to identify a total weight supported by each landing gear strut.

The methods of prior art aircraft weighing systems, determine the “sprung” weight of the aircraft by measuring the pressure within the landing gear struts and multiplying strut pressure by the load supporting surface area of the strut piston; or as an alternative method, monitoring landing gear strut axle deflection as additional weight is added to the aircraft. Among the disadvantages of the prior art onboard aircraft weight measuring systems are that airlines can suffer severe schedule disruptions by using a “measured” aircraft weight value, as opposed to methods of “calculating” aircraft weight based upon the LBUM.

Aircraft load planning is a crucial part of keeping an airline running on schedule. A scheduled aircraft departure will commence its load planning process up to one year prior to the actual flight. Airlines do not offer ticket sales for a flight, more than twelve months prior to the flight. As each ticket for a scheduled flight is purchased, the average passenger and average checked bag weights are assigned into a computer program, continually updating throughout the year the planned load for that flight. Aircraft have a Maximum design Take-Off Weight “MTOW” limitation, where airline operations use assumptions as to the weight of passengers and baggage loaded onto the aircraft, to stay below the aircraft MTOW limitation.

AC 120-27E designates the approved weight assumptions/assignments for airline passengers and baggage:

| | |
|---|---|
| Average passenger weight - summer | 190.0 lb. |
| Average passenger weight - winter | 195.0 lb. |
| Average bag weight | 28.9 lb. |
| Average heavy bag weight | 53.7 lb. |

Historical weather events regarding wind velocity and direction, combined with storm patterns along scheduled airline routes are also considered when planning the amount of fuel that will be consumed for a potential flight. On the actual day of a flight, typically two hours prior to the departure of that flight, the flight's automated load planning program will be transferred to the desktop computer display of one of the airline's Flight Dispatchers. It is the responsibility of the Flight Dispatcher to then monitor the planned load of that flight as passengers check-in at the gate. The passengers and number of checked bags are input to the load planning program. Typically this process goes without interruption and the aircraft will dispatch on schedule, as planned. As the door of the aircraft is closed and the load-plan is closed-out by the Flight Dispatcher, the “planned load” will always match the “departure load” as submitted to the FAA; because both are based on the same compilation of weight assumptions used in determining the LBUM. Using a means to measure the actual aircraft weight, just as the aircraft door closes, and the possibility of the measured weight not matching the calculated weight of the LBUM, would have the airline facing a potential departure delay to resolve any difference in the two separate but parallel weight determinations. This potential for delay in the flight departure, on as many as 2,200 daily flights for a single airline, results in the various airlines not willing to take the risk of hundreds of flight delays each day. Many if not most airlines currently dispatch their aircraft under FAA approved LBUM procedures; a method which helps to keep the airlines on schedule. This creates an incentive for airlines to continue to use the FAA approved assumed weights, irregardless to whether the assumed aircraft weight determination is accurate. The FAA has expressed concerns regarding any airline which might measure total aircraft weight, but chose to not disclose such measured total aircraft weight on the aircraft flight manifest.

Airlines would appreciate an opportunity to use the CG tracking capabilities of today's aircraft weight and balance systems, to more efficiently place baggage and cargo below decks, and take advantage of the reduced fuel consumption benefits; but are not willing to take the risk of scheduled departure delays when the aircraft's planned weight as determined by weight assumptions does not match an actual measured total aircraft weight.

The methods described herein are applicable as alternatives to existing prior art aircraft weight and balance measuring systems for determining aircraft CG, independent of measuring the entire weight of the aircraft, but rather measuring only the weight supported by the nose landing gear, to further determine the remaining weight supported by the main landing gear, to further determine the aircraft CG.

### SUMMARY OF THE INVENTION

It is an object of the present invention to provide a method to determine aircraft CG, without the requirement to measure the entire weight of the aircraft.

A method determines a Center of Gravity of an aircraft on the ground and having plural main landing gear struts and a nose landing gear strut. Each of the main and nose landing gear struts supporting a respective amount of aircraft weight when the aircraft is on the ground. The method determines a total weight of the aircraft, independent of measuring the aircraft weight. A weight supported by the nose landing gear strut is measured. The measured nose strut weight is compared to the total aircraft weight as a percentage. The aircraft Center of Gravity is identified as a percentage of the distance between the nose and main landing gear struts.

In accordance with one aspect, the step of measuring a weight supported by the nose landing gear strut further comprises the step of measuring an internal pressure within the nose landing gear strut.

In accordance with another aspect, the nose landing gear strut has an axle. The step of measuring a weight supported by the nose landing gear strut further comprises the step of measuring a deflection in the nose landing gear strut axle.

In accordance with another aspect, the step of measuring a weight supported by the nose landing gear strut further comprises the step of measuring rotation of a linkage on the nose landing gear strut.

In accordance with another aspect, the step of measuring a weight supported by the nose landing gear strut further comprises the step of placing a scale beneath the nose landing gear strut tires.

In accordance with another aspect, the step of determining the total weight of the aircraft further comprises the step of using a load build-up process of applying assumed weight values for items such as fuel, passengers and baggage, to the empty measured weight of the aircraft.

In accordance with another aspect, the aircraft is flown under a Regulatory Authority and the load build-up weight values for the passengers and baggage are approved by the Regulatory Authority.

In accordance with another aspect, further comprising the step of dispatching the aircraft for a flight using the determined aircraft Center of Gravity and the independently determined aircraft weight.

In accordance with another aspect, the step of determining the aircraft Center of Gravity further comprises the step of determining the aircraft Center of Gravity as a distance measured from the aircraft datum line.

In accordance with another aspect, the step of determining the aircraft Center of Gravity further comprises the step of determining the aircraft Center of Gravity as a % MAC.

In accordance with another aspect, the step of determining the aircraft Center of Gravity further comprises the step of determining the aircraft Center of Gravity as a distance relative to an aircraft station number.

A method determines a Center of Gravity of an aircraft on the ground and having plural main landing gear struts and a nose landing gear strut. Each of the main and nose landing gear struts supporting a respective amount of aircraft weight when the aircraft is on the ground. A total weight of the aircraft is determined, independent of measuring the aircraft weight. The aircraft weight comprises the operating empty weight of the aircraft, the weight of fuel on board, the weight of payload items on board including the weight of passengers on board, and the weight of baggage on board. The weights of the passengers and the baggage being determined by Regulatory Authority approved designated weights. A weight supported by the nose landing gear strut is measured. The weight determined by the combined main landing gear struts is determined by removing the measured nose strut weight from the independently determined total aircraft weight. The determined combined main landing gear strut weight is compared to the total aircraft weight to identify the aircraft Center of Gravity as a percentage of the distance between the nose and main landing gear struts.

In accordance with one aspect, the step of measuring a weight supported by the nose landing gear strut further comprises the step of measuring an internal pressure within the nose landing gear strut.

In accordance with another aspect, the nose landing gear strut has an axle. The step of measuring a weight supported by the nose landing gear strut further comprises the step of measuring a deflection in the nose landing gear strut axle.

In accordance with another aspect, the step of measuring a weight supported by the nose landing gear strut further comprises the step of measuring rotation of a linkage on the nose landing gear strut.

In accordance with another aspect, the step of measuring a weight supported by the nose landing gear strut further comprises the step of placing a scale beneath the nose landing gear strut tires.

In accordance with another aspect, step of determining the total weight of the aircraft further comprises the step of using a load build-up process of applying designated weight values for items such as fuel, passengers and baggage, to the empty measured weight of the aircraft.

In accordance with another aspect, the aircraft is flown under a Regulatory Authority. The load build-up weight values for the passengers and baggage are approved by the Regulatory Authority.

In accordance with another aspect, the step of dispatching the aircraft for a flight using the determined aircraft Center of Gravity and the independently determined aircraft weight.

In accordance with another aspect, the step of determining the aircraft Center of Gravity further comprises the step of determining the aircraft Center of Gravity as a distance measured from an aircraft datum line.

In accordance with another aspect, the step of determining the aircraft Center of Gravity further comprises the step of determining the aircraft Center of Gravity as a % MAC.

In accordance with another aspect, the step of determining the aircraft Center of Gravity further comprises the step of determining the aircraft Center of Gravity as a distance relative to an aircraft station number.

A method determines a Center of Gravity of an aircraft on the ground and having plural main landing gear struts and a nose landing gear strut. Each of the main and nose landing gear struts supporting a respective aircraft weight when the aircraft is on the ground. A total weight of the aircraft is determined independent of measuring the weight supported by the nose landing gear strut. A combined weight supported by the plural main landing gear struts is measured. The measured weight supported by the plural main landing gear struts is compared to the total weight of the aircraft to determine the aircraft Center of Gravity.

### BRIEF DESCRIPTION OF THE DRAWINGS

Although the features of this invention, which are considered to be novel, are expressed in the appended claims; further details as to preferred practices and as to the further objects and features thereof may be most readily comprehended through reference to the following description when taken in connection with the accompanying drawings, wherein:

FIG. 1 is a side view of a typical commercial airline aircraft, with a tricycle type landing gear in the extended position, supporting the total weight of the aircraft, resting on the ground, illustrating the location of the aircraft's longitudinal CG along the aircraft's horizontal axis, and the aircraft's Mean Aerodynamic Chord hereinafter referred to as “MAC” along with various components of the preferred embodiment.

FIG. 2 is a chart illustrating a typical Load Build-Up Method “LBUM” used by many airlines to determine total aircraft weight, as a substitute for measuring the aircraft weight before each flight departure.

FIG. 3 is an example of a 737-800 weight and balance control and loading chart illustrating the forward and aft limitations for aircraft CG, at various aircraft weights.

FIG. 4 is a side view of a typical aircraft telescopic landing gear strut, with various elements of the preferred embodiment attached to the landing gear strut.

FIG. 5 is a front view of a typical aircraft telescopic landing gear strut, with various elements of the preferred embodiment attached to the landing gear strut.

FIG. 6 is a perspective view of the aircraft landing gear footprint, and method for aircraft CG determination.

FIG. 7 is a schematic diagram of the onboard computer with sensor inputs that support the CG calculation software programs of this invention.

### DETAILED DESCRIPTION OF THE PREFERRED EMBODIMENT

An aircraft is typically supported by plural landing gear struts. In many if not most cases, the aircraft is supported by three landing gear struts. Each landing gear strut is designed much like and incorporates many of the features of a telescopic shock absorber. The shock absorber of the landing gear strut comprises internal fluids of both hydraulic oil and compressed nitrogen gas. More simply said the weight of an aircraft rests on three pockets of compressed nitrogen gas. Pressure contained within the landing gear struts is measured in “psi”. With any object that has a “known total weight” which is resting on three independent points, and one of the three points has a measured weight, the combined weight supported by the remaining two points can be determined by subtracting the one measured weight from the known total weight.

The present invention offers a new method to determine aircraft CG. Total aircraft weight is determined independently of measuring the weight supported at all of the landing gear struts. In the preferred embodiment, the total aircraft weight determination incorporates LBUM calculations. The weight supported by the nose landing gear strut is measured. This measured weight allows for the computation of the weight supported by the combined main landing gear struts, to further determine aircraft CO without a need to measure the weight supported by the combined main landing gear struts. This new method for determining aircraft CG is independent of using a measured total weight of the aircraft, or a measured weight supported by the combined main landing gear struts.

Typically the nose landing gear supports 8%-16% of the total aircraft weight, depending upon the location of aircraft CG; where the remainder of the weight is supported by the combined main landing gear. As aircraft CG moves either forward or aft, the relationship or ratio of nose landing gear weight as related to combined main landing gear weight will change in direct relation to the change in aircraft CG. The weight supported by the combined main landing gear struts, divided by the total weight of the aircraft as a percentage, will determine the location of the aircraft CG as a percentage of the distance between the nose landing gear and the main landing gear, measured aft from the location of the nose landing gear, or as a percentage of the wheel-base distance.

Measuring internal gas pressure within the nose landing gear strut, and applying adjustments to the nose gear pressure, which adjustments are made to correct for landing gear strut seal friction (reference is made to U.S. Pat. No. 5,214,586 and No. 5,548,517), allows for the measured calculation of the weight supported by the nose landing gear.

With the entire weight of the aircraft distributed between the nose landing gear and the combined man landing gear, then subtracting the measured weight supported by the nose gear from the total aircraft weight calculation made by the LBUM, determines a computed weight supported by the combined main landing gear struts. A further comparison of the determined or computed weight supported by the combined main landing gear to that of the total weight, the aircraft CG can be identified without the need to measure the total aircraft weight.

Alternative measurements of strut supported weights may be used. For example, the present invention additionally offers a method to measure weight supported by the nose landing gear strut by measuring landing gear strut component yielding bending on such components as the landing gear axle or mounting trunion pins which attach the landing gear to the airframe, by strain gauge sensors bonded to these yielding components. As another alternative, the aircraft weight on the combined main landing gear struts can be measured and then subtracted from the total aircraft weight to determine nose landing gear weight; then such determined nose landing gear weight further compared to the total aircraft weight to determine aircraft CG.

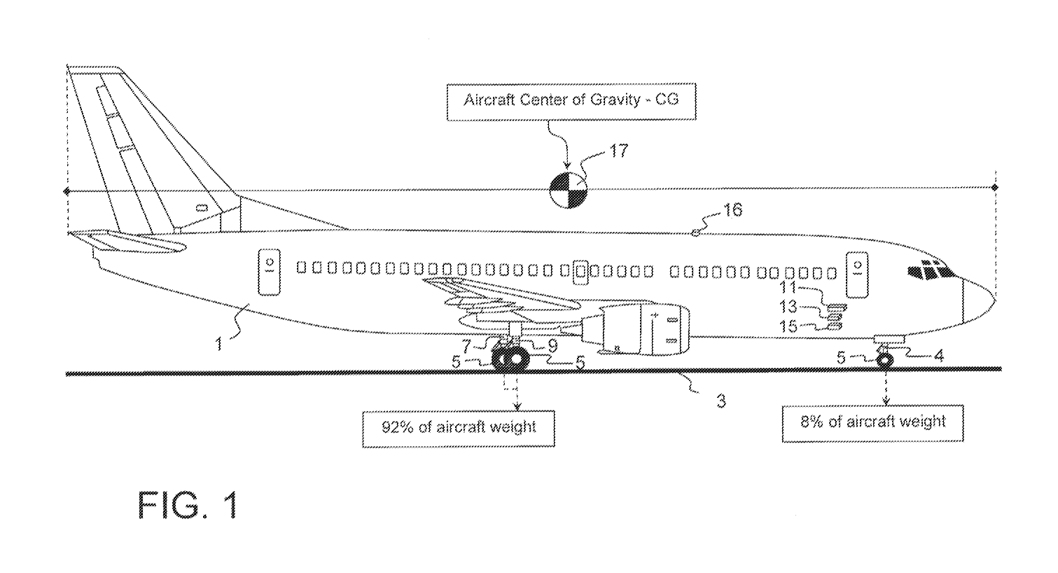

Referring now to the drawings, wherein like reference numerals designate corresponding parts throughout the several views and more particularly to FIG. 1 thereof, there is shown a typical commercial 737-800 aircraft 1. All variations and types of aircraft are required to have a vertical “datum line” 3 which is a non-changeable reference point, designated by the aircraft manufacturer, which is used in calculations of the aircraft CG 5. (The CG 5 is located inside of the aircraft 1, but in this illustration is shown above aircraft 1, for better visibility). A black and white patterned disk representing aircraft CG 5 identifies the longitudinal location of aircraft CG 5 along longitudinal aircraft axis line 7. Aircraft CG 5, is measured along aircraft longitudinal axis 7, and can be referenced in various ways by different airline operations. As an example, units of measure can be referenced in inches or in centimeters, measured aft of the aircraft datum line 3. This form of reference is referred to as the CG 5 located at a particular “station number” for the aircraft 1. As an additional example, the location of aircraft CG 5 may be referenced at a location measured as a percentage of the distance from the leading edge of the aircraft's Mean Aerodynamic Chord (% MAC).

The MAC is the average (Mean) width of the wing's lifting surface (Aerodynamic Chord). In the case of a swept-wing aircraft 1, the leading edge of the MAC is locative just aft of the leading edge of the wing where it attaches to the aircraft 1. The trailing edge of the MAC is located just forward of the aft wing-tip. Airline operations often reference the aircraft CG 5 location as a point some percentage aft of the forward edge of the mean aerodynamic chord, or as % MAC.

Aircraft 1 has a tricycle landing gear configuration consisting of a nose landing gear 9, and also shown two identical main landing gears including a right main landing gear 11 and a left main landing gear 13. Main landing gears 11 and 13 are located at the same point along the aircraft's horizontal axis 7, but for convenience in this illustration, are shown in a perspective view for this FIG. 1. Vertical arrow 21 passes downward through the center of the load-path for nose landing gear 9. Vertical arrow 23 passes downward at a location through the aircraft's longitudinal axis 7 at a point that is equivalent to the common load-path for right main landing gear 11 and left main landing gear 13. Main landing gears 11 and 13 typically support an equalized amount of weight. Thus this illustration shows 86.50% of the aircraft weight supported by the combined right main landing gear 11 and left main landing gear 13, with the remaining 13.50% of the aircraft weight supported by nose landing gear 9.

Continuing with the example, 100% of aircraft 1 weight totals 163,800 lb. The distribution of the total aircraft weight has 86.50% of aircraft weight supported by the combined main landing gears 11 and 13 at 141,687 lb. and the remaining 13.50% of aircraft weight supported by nose landing gear 9 at 22,113 lb.

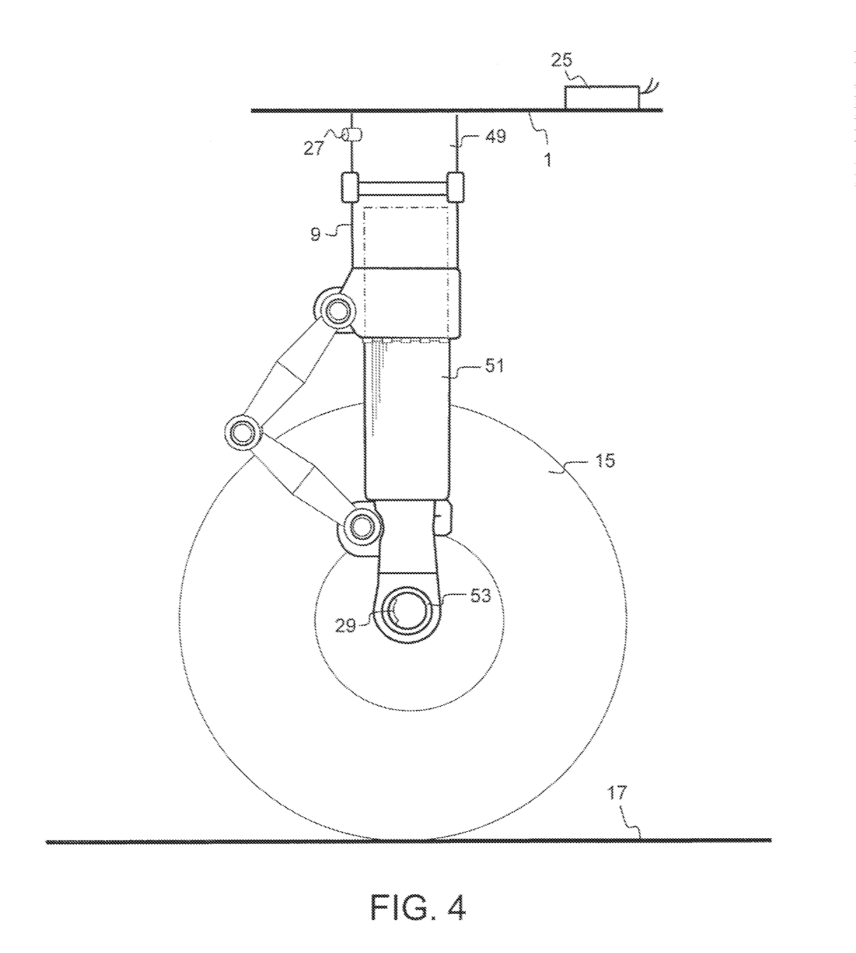

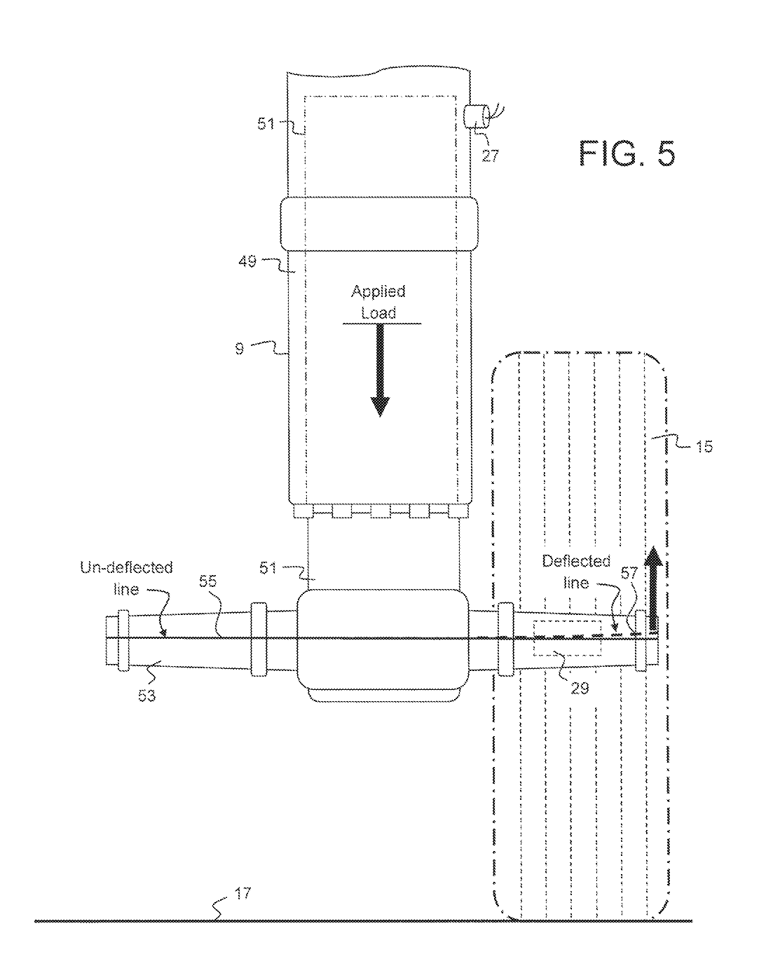

Landing gear 9, 11 and 13 incorporate one or more tires 15 to distribute the weight of aircraft 1 which is resting on the ground 17. Electronic elements which together are used in this invention, and are attached to aircraft 1, are an aircraft center of gravity measurement computer 19; and aircraft inclinometer 25, landing gear strut pressure sensors 27 with embedded temperature probes (shown in FIG. 4 and FIG. 5), and landing gear axle deflection strain gauge sensors 29 (shown in FIG. 4 and FIG. 5). Computer 19 contains various internal circuit boards for processing the calculations and measurement of the weight supported by the nose landing gear 9, and further processing to determine the weight supported by combined right and left main landing gears 11 and 13; and further calculation of aircraft CG 5. A cockpit display/keypad 20 allows the aircraft pilots to input data into computer 19. Computer 19 also makes refinements in calculation of aircraft CG 5, from possible variation in aircraft 1 incline, due to possible slope in ground 17.

Although the aircraft shown in FIG. 1 is a commercial airline aircraft, the depiction of this larger aircraft is by way of an example, as the apparatus and methods described herein can be used on most types and sizes of aircraft, including corporate aircraft, which utilize pressurized, telescopic landing gear struts.

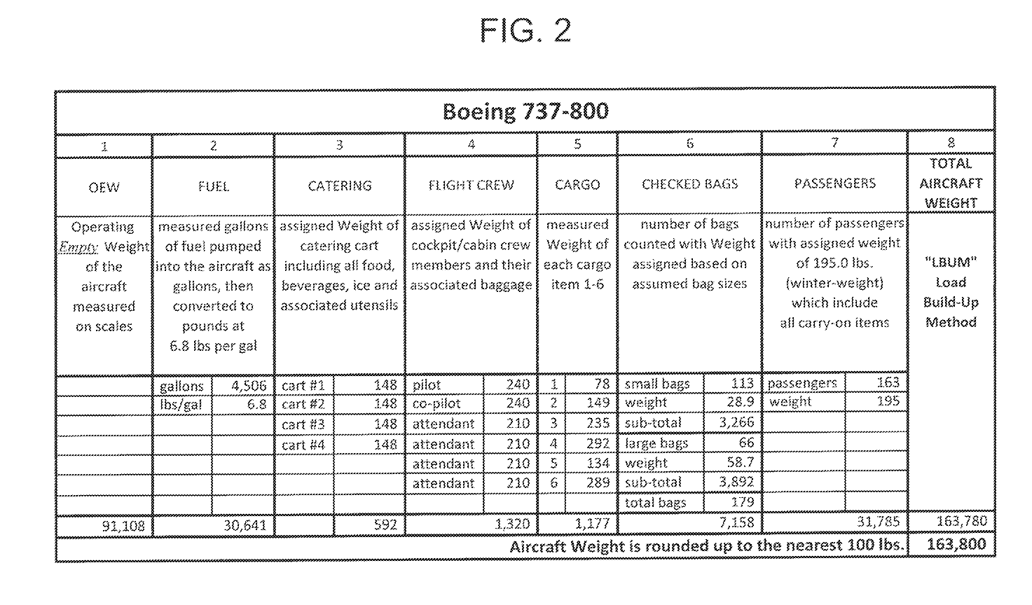

Referring now to FIG. 2 there is shown a chart listing various weight categories for which airlines typically address to determine the total weight of an aircraft before flight. This practice is commonly called the Load Build-Up Method “LBUM”. The aircraft selected for the example is the Boeing 737-800. The chart is divided into eight columns with each column number 1-8 shown at the top of each column.
Column 1 represents the Operating Empty Weight “OEW” of the aircraft. The OEW is the weight of the empty aircraft. One way to measure the empty weight of the aircraft is to roll it onto three platform weighing scales with one landing gear resting on each of the scales. Each scale measures the weight supported by each respective landing gear and the weights are added together. Another way to measure the empty weight of an aircraft is to place it onto tripod floor-jacks and lifted up and off of the hanger floor. A load-cell is located at the top of each floor-jack, so that once the aircraft is suspended the weight of the aircraft rests on the three load-cells. The OEW is then measured and the aircraft CG is further determined from the measured aircraft weight. Though the term OEW identifies the aircraft as empty, the aircraft is empty of fuel, payload and crew. Other items such as engine and systems hydraulic fluid, in-flight magazines, galley items such as coffee-makers and other lavatory items are considered part of, and are included in the OEW. In this example, the OEW of the Boeing 737-800 aircraft is 91,108 lb. Aircraft are reweighed on a periodic basis to account for changes in operating empty weight.
Column 2 represents the weight of the fuel which is carried within the aircraft fuel tanks. In the determination of aircraft weight, the fuel weight is determined by recording aircraft fuel indicator readings. Fuel is pumped onto the aircraft through flow-meters which measure the fuel flow in gallons, and the aircraft fuel tanks have sensors which convert the volume of fuel contained within each tank into a quantity indicated in pounds. The typical conversion rate is 6.8 pounds per gallon of fuel. In this example 4,506 gallons of fuel are contained within the fuel tanks, totaling 30,641 lb.
Column 3 represents the weight associated with the food, beverages and other catering items consumed during the flight. Airlines typically use catering carts which are pre-loaded with food, beverages and ice, prior to being loaded onto the aircraft. There are several types of catering carts; either a lighter cart filled with trays of food, or a heavier cart filled with canned soda beverages and ice; is selected. Each respective cart has a standard weight assigned to it based on the size and capacity of the cart. In this example four of the heavier 148 lb. beverage carts are loaded onto the aircraft, totaling 592 lb.
Column 4 represents the weight of the flight crew. The airline flight crew weights are divided into two categories: pilot-crew and cabin-crew. FAA regulations regarding assumed/assigned/designated weight values used in the LBUM are contained within FAA Advisory Circular-AC 120-27E. AC120-20E assigns a weight for each pilot at 240 lb. The pilot is assumed to be carrying personal baggage and additional flight charts and aircraft manuals onto the aircraft. FAA regulations require 2 pilots (including a co-pilot) for this FAA Part 25 category of aircraft. FAA Regulations require one flight attendant for each block of 50 passengers, for which the aircraft is certified to carry. AC120-27E assigns a weight for each cabin attendants at 210 lb., which includes personal baggage. The Boeing 737-800 aircraft is certified to carry a maximum of 198 passengers, thus the weight of 4 cabin attendants for this size of aircraft is applied. Combined pilot and cabin attendant weights total 1,320 lb.
Column 5 represents the measured weight of the cargo loaded. Each of the 6 respective cargo items for this example flight are pre-weighed on scales prior to being loaded onto the aircraft. The cargo weight for this flight totals 1,177 lb.
Column 6 represents the weight of the checked bags (those bags which are loaded into the baggage compartments located below the aircraft cabin floor). AC120-27E assigns weight values for two types of checked bags, depending on the assumed size of each bag. Smaller bag weights are assigned at 28.9 lb. each. Larger bag weights are assigned at 58.7 lb. each. For this flight there are 113 small bags totaling 3,266 lb., plus an additional 66 large bags totaling 3,892 lb., for a combined checked bag weight total of 7,158 lb.
Column 7 represents the weight of 163 passengers for this flight. AC120-27E assigns weight values for average passenger weights at 190 lb. for summer weights and 195 lb. for winter weights. It is assumed that during colder months, passengers will include more clothing as they board the aircraft. The summer average passenger weight of 190 lb. is used between May 1^{st}-October 31^{st} and winter weight of 195 lb. is used between November 1^{st}-April 30^{th}. With this example, the higher 195 lb. winter weight is being used. The passenger weight includes carry-on items. Such carry-on items include bags, purses, small luggage, backpacks, etc. With all tickets passenger boarding the aircraft, the weight of 163 passengers total 31,785 lb.
Column 8 represents the total weight of the aircraft. Summing the totals along the bottom of columns 1-7 equals a 163,780 lb. determination for the aircraft total weight. Typical airline operations round-up the weight determination to the nearest 100 lb. increment. The 163,780 lb. accumulation is increased to 163,800 lb. of aircraft total weight as determined by the LBUM.

The items listed in this LBUM example, represent some but not all items a specific airline may choose to build their individual FAA approved weight and balance control system, but different items may be selected as elements categorized in other airlines' FAA approved LBUM method. Examples of other items which are not listed above can be standardized cargo articles which maintain a constant weight. Some airlines carry various maintenance tools and spare aircraft components for which these weights do not vary, but are separately noted within that airline's particular LBUM.

In the United States of America, the FAA is the Regulatory Authority that approves the designated weights. In other countries or regions, other Regulatory Authorities may have jurisdiction.

The LBUM weight determination is transmitted to the pilot of aircraft 1, and the pilot will manually input the LBUM total aircraft weight determination into computer 19 via keypad 20 (see FIG. 1.)

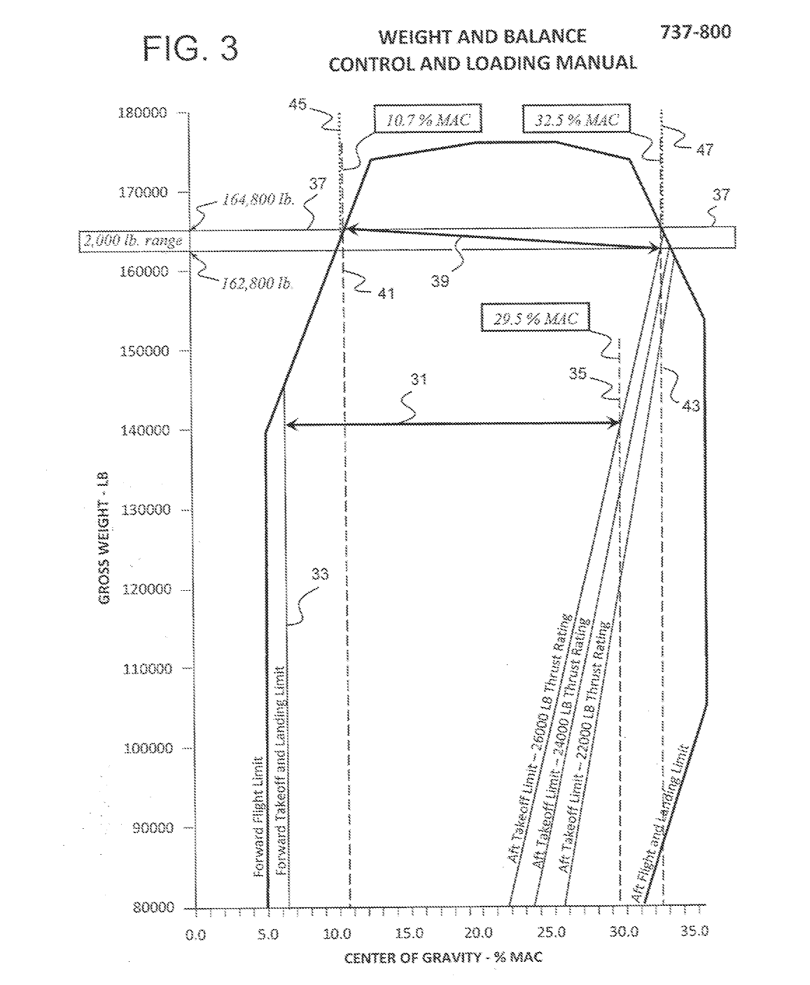

Referring now to FIG. 3 there is shown an example of a 737-800 aircraft “WEIGHT AND BALANCE—CONTROL AND LOADING MANUAL” chart, typically referred to as the aircraft weight and CG envelope. The weight and CG envelope define the forward and aft CG limitations at which the aircraft can safely operate. The forward and aft CG limits of safe operation will vary depending on the amount of aircraft weight, and the amount of engine thrust used during the takeoff roll.

As discussed in the “background” section above, many airlines determine aircraft weight using designated weight values based on historical weight data for various elements such as passengers, baggage and small cargo loaded onto the aircraft. A pre-measured empty aircraft weight is associated with the sum of the designated weights of the accumulated items loaded onto the aircraft, without the need to physically place the aircraft on weighing scales prior to each departure.

Shown initially on this chart as a 1u example, the horizontal double-arrow 31 illustrates the forward and aft CG limitations of an aircraft having a weight of 140,000 lb. The forward CG limitation for take-off and landing is 6.4% MAC, illustrated by the “Forward Takeoff and Landing Limit” line 33. The aft CG limit for the 140,000 lb. aircraft is 29.5% MAC illustrated by vertical dashed line 35, in this example, dashed line 35 intersecting at the higher engine thrust setting of 26,000 pounds.

When using this size of chart, typically on 8½×11″ paper, it is very difficult in making a distinction between the forward CG limit of an aircraft weighing 163,700 lb. to that of an aircraft weighing 163,800 lb. This is widely understood within the airline industry, thus when determining the CG limitation for a loaded aircraft, the pilots often will use a weight that has been rounded up to the nearest 1,000 lb.

By way of this 2^{nd} heavier example, the aircraft weight has been established within an acceptable 2,000 lb. range (±1,000 lb.) for the further determination of acceptable CO limitations within FAA Regulatory requirements. Though the ±1,000 lb. weight range may be acceptable for the CG determination, such weight conclusion would not be accurate enough, thus unacceptable to FAA Regulatory requirements as a means to determine aircraft “dispatch weight” being the official aircraft weight used prior to the take-off for a flight. For this 2^{nd} example a LBUM calculated weight of the aircraft is 163,800 lbs., falling within the 2,000 lb. weight range between 162,800 lb. and 164,800 lb.; where box 37 illustrates the 2,000 lb. range representing a possibility for potential weight determination error of ±1,000 lb. The forward and aft CG limitations are illustrated by the bold “diagonal” double-arrow 39 pointing to a forward CG limit of 10.7% MAC illustrated by vertical dashed-line 41, with the opposing end of double arrow 39 pointing to an aft CG limit of 32.5% MAC illustrated by vertical dashed-line 43. Double-arrow 39 is shown as diagonal due to an “implied curtailment” applied to both forward and aft CG limits associated with the ±1.000 lb. range of the weight determination. Vertical dotted-line 45 (which is slightly forward of dashed-line 41) illustrates the forward CG limit for the aircraft with a weight determination at “precisely” 163,800 lb. Vertical dotted-line 47 (which is slightly aft of dashed-line 43) illustrates the aft CG limit for the aircraft with a weight determination at “precisely” 163,800 lb. There is negligible difference between the locations of dotted-line 45 representing the forward CG limit using an accurate aircraft weight, to that of dashed-line 41 using an assumed aircraft weight range of ±1,000 lb. There is negligible difference between the locations of dotted-line 47 representing the aft CG limit using an accurate aircraft weight, to that of dashed-line 43 using an assumed aircraft weight range of ±1,000 lb. The negligible difference in the forward and aft aircraft CG limitations, based upon a ±1,000 lb. range in the determination of the aircraft weight, allows fir aircraft weight determinations to be made within a pre-defined acceptable range of accuracy (in this example ±1,000 lb.) resulting in forward and aft CG limitation curtailments which are negligible but still more conservative than the limitations associated with the “precise” weight of 163,800 lb.

Referring now to FIG. 4 there is shown a side view of a typical aircraft telescopic nose landing gear strut 9, further identifying landing gear strut cylinder 49, in which strut piston 51 moves telescopically within strut cylinder 49. Pressure and temperature within nose landing gear 9 is monitored by a pressure/temperature sensor 27. All weight supported by tire 15 is transferred through axle 53, to piston 51; resulting in variations to nose gear strut 9 internal pressure, as recorded by pressure-temperature sensor 27. Deflection of axle 53 (shown in FIG. 5) is measured by strain gauge sensor 29. Any changes in the angle of inclination for aircraft hull 1 are measured by inclinometer 25. As additional weight is applied to nose strut 9, telescopic piston 51 will recede into strut cylinder 49, reducing the interior volume within nose landing gear strut 9 and increasing internal pressure in proportion to the amount of additional weight applied. Pressure sensor 27 will measure changes of strut pressure.

Referring now to FIG. 5 there is shown a front view of nose landing gear strut 9 further identifying landing gear strut cylinder 49, in which strut piston 51 moves telescopically within strut cylinder 49. Landing gear strut piston 51 attached to an axle 53 which uses a wheel and tire 15 to transfer aircraft weight to the ground 17. Pressure within nose landing gear 9 is monitored by a pressure sensor 27. Pressure measured by pressure sensor 27 is proportional to the amount of applied weight onto nose landing gear 9. The applied weight to nose landing gear 9 is measured by axle deflection sensor 29 which is bonded to axle 53. Axle deflection sensor 29 can be of the strain gauge variety, which measures the vertical deflection of axle 53. A bold solid line 55 is shown running horizontal across the center-line of landing gear axle 53 and represents an un-deflected stance of the landing gear axle 53. As additional weight is applied the nose strut 9, axle 53 will deflect. A bold dashed-line 57 illustrates a very slight curve; representing vertical deflection from solid line 55 of axle 53 and is shown running adjacent to the un-deflected bold solid line 55. The amount of deflection of landing gear axle 53 is directly proportional to the amount of weight applied. As weight is applied to nose gear strut 9, the increase in weight will be immediately sensed by the additional deflection of axle 53 and measured by strain gauge sensor 29.

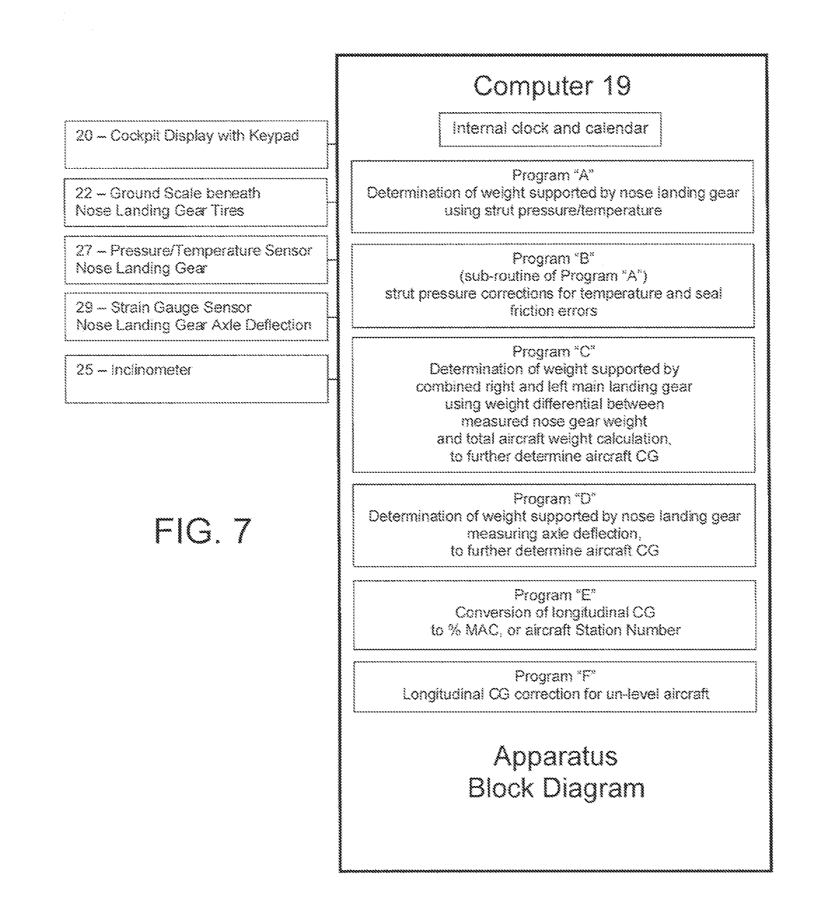

Axle deflection sensor 29 will transmit a signal representing the weight applied to the nose landing gear strut 9, to the system computer 19 (shown in FIG. 1 and described in FIG. 7). A software look-up table is generated to measure deflection values received from nose strut sensor 29, to measure the weight supported by nose strut 9, for the further determination of aircraft CG.

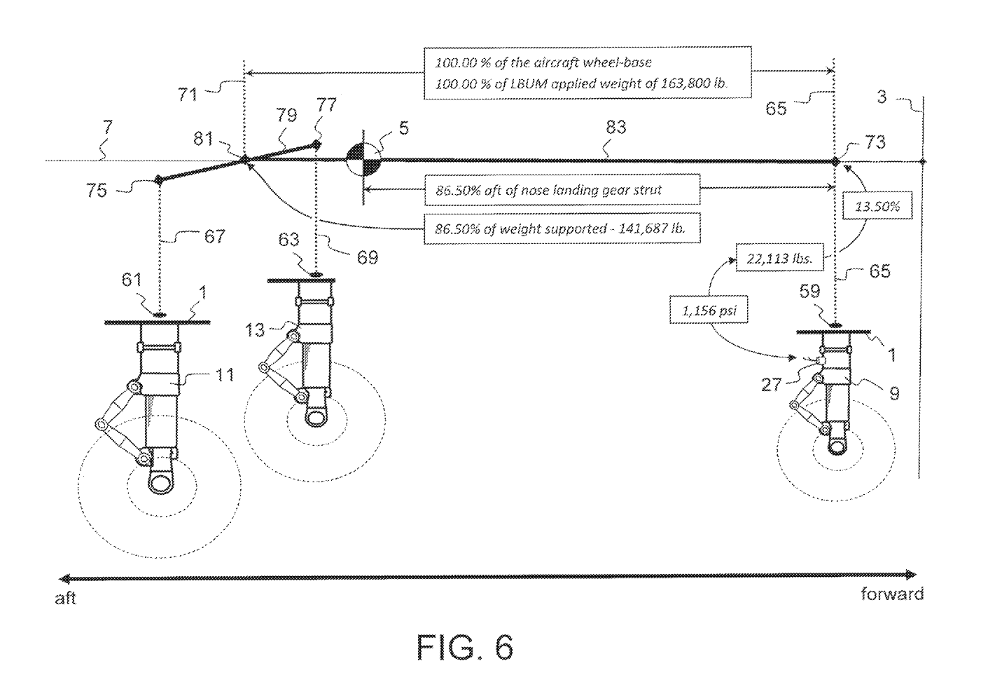

Referring now to FIG. 6, there is shown a perspective view of the aircraft 1 landing gear footprint, being nose landing gear 9 in relation to right main landing gear 11 and left main landing gear 13.

Located directly above nose landing gear 9 is a black circle 59 (shown in this perspective view as an oval) which represents the location for which nose landing gear strut 9 supports weight. Located directly above right main landing gear 11 is a black circle 61 (shown as an oval) which represents the location for which right main landing gear strut 11 supports weight. Located directly above left main landing gear 13 is a black circle 63 (shown as an oval) which represents the location for which left main landing gear strut 13 supports weight. Located directly above nose landing gear black circle 59 and located along vertical dotted-line 65 is reference point 73 which represents the center of the weight supporting area for the nose landing gear strut 9, located along aircraft longitudinal axis line 7. Located directly above right main landing gear black circle 61 and located at the opposing end of vertical dotted-line 67 is reference point 75 which represents the center of the weight supporting area for right main landing gear strut 11. Located directly above left main landing gear black circle 63 and located at the opposing end of vertical dotted-line 69 is reference point 77 which represents the center of the weight supporting area for left main landing gear strut 13. Line 79 is perpendicular to aircraft longitudinal axis line 7 and connects right main gear reference point 75 and left main gear reference point 77, passing through reference point 81 which is located on line 79 at the intersection of line 79 with aircraft longitudinal axis line 7. Reference point 81 is an equal-distance between reference points 75 for the right main landing gear and reference point 77 for the left main landing gear. Reference point 81 is the location along aircraft longitudinal axis 7 corresponding to the point at which the supported weight by the combined right and left main landing gear would be assigned, in the calculation of aircraft CG 5. Any weight supported by the combined right and left main landing gear struts will be apportioned to this reference point 81 location along longitudinal axis line 7. The position of point 73, is located aft from the datum line 3 (also shown in FIG. 1), and is a known value. Bold-line 83 extends along and parallel to the aircraft's longitudinal axis 7 (bold-line 83 is shorter than, and overlays line 7). Bold-line 83 intersects perpendicular line 79 at point 81 corresponding to the location of right main landing gear 11 and left main landing gear 13. Though bold-line 83 and aircraft longitudinal axis 7 are coaxial or parallel, bold-line 83 is the measured distance between reference point 73 being the location of the nose gear 9 and the intersection of perpendicular line 79, at reference point 81 identifying the location of combined main landing gears 11 and 13. Vertical dotted-line 71 extends up from reference point 81 and references the extended location for applied weight determinations of the combined right and left main landing gear 11 and 13. Vertical dotted-line 65 extends through reference point 73 and references the location for any applied weight measurements of the nose landing gear 9.

As shown in FIG. 1, the black and white patterned disk representing aircraft CG 5 identifies the longitudinal location of aircraft CG 5 along line 7. The aircraft CG 5 is determined using the relationships of the determined weight supported by the combined main landing gears 11 and 13, calculated as a percentage of the total weight of the aircraft; identified as a distance aft of the location of the nose landing gear strut 9. Nose landing gear strut 9 pressure measurements are subsequently corrected for variations in temperature, as measured by a temperature probe feature of pressure sensor 27 and a software algorithm in computer 19 (shown in FIG. 1 and described in FIG. 7). Aircraft landing gear struts are designed for various loads and endurance. The main landing gear are designed to withstand the extreme loads associated with very hard landing events and carry the majority of the weight of the aircraft, thus the main landing gear must be sized larger, to withstand extreme landing loads. The nose landing gear absorb much less of the landing loads during each landing event, where the responsibility of the nose landing gear is for basic aircraft balance of about 8-16% of the aircraft weight; and used to steer the aircraft while on the ground.

In the preferred embodiment, the method for determining aircraft CG includes the following steps:
1. Determine the total “calculated” weight of the aircraft using existing and established airline procedures with the LBUM process (fir example see FIG. 2);
2. Determine the actual “measured” weight supported by nose landing gear strut 9 (by way of an example, one means may be by multiplying the pressure in the strut by the surface area of the strut piston 51). There are many numerous methods for measuring or determining the weight supported by the nose landing gear strut. Some of these methods are:
   Placing a scale beneath the nose landing gear tires,
   Measuring the angle of a properly serviced nose landing gear strut torque-link will allow for measurement of the volume within the nose landing gear strut, where internal volume is directly proportional to internal pressure, where the pressure is measured without the use of a pressure sensor,
   Measurement of the yielding or deflections of nose landing gear strut connection trunion pins where they attach to the aircraft hull,
   Measurement of the dual nose landing gear tire pressure, in combination with the measurement of the surface area of the tire footprints onto the ground,
   Use of a LVDT to measure the telescopic strut extension of the nose landing gear, to determine the internal pressure within the nose landing gear strut, to further determine the weight supported,
   Use of a laser range-finder to measure the telescopic strut extension of the nose landing gear, to determine the internal pressure within the nose landing gear strut,
   Though any of the methods described may be used with potential variations in overall accuracy of the weight determination, the preferred method is to use a pressure sensor to measure internal strut pressure to further determine weight supported by the nose landing gear strut.
3. Subtract the value of the “measured” weight supported by nose gear 9 from the LBUM “calculated” total aircraft weight, to determine a “computed” weight supported by combined main landing gears 11 and 13;
4. The measured weight value supported by nose landing gear 9, and the computed weight value associated with the combined main landing gear 11 and 13, are now known values;
5. Determine the location of aircraft CG 5 by further calculating the amount of weight supported by main landing gears 11 and 13, as a percentage of the total weight of the aircraft; which is the location of aircraft CG 5 measured as a percentage of the distance between the nose landing gear 9 and the combined main landing gear 11 and 13;
6. As an alternative method to determine the location of aircraft CG 5, identify the amount of weight supported by nose landing gear 9 as a percentage of the total weight of the aircraft; subtracted from 100%
7. As an additional method, determine the location of aircraft CG 5 by comparison of weight assigned at point 73 representing nose landing gear 9, to that of weight assigned at point 81 representing the combined weight supported by main landing gears 11 and 13, in relation to the total weight of the aircraft.

As illustrated in FIG. 1, the distance between arrow 21 and arrow 23 represents 100% of the wheel-base distance between nose landing gear 9 and combined right and left main landing gear 11 and 13.

As illustrated in FIG. 6, the distance between reference point 73 and reference point 81 represents 100% of the wheel-base distance between nose landing gear 9 and combined right and left main landing gear 11 and 13.

In this example, the aircraft CG 5 is located 86.50% aft of point 73. Point 73 is the forward edge of the aircraft wheel-base, and aircraft CG 5 is located 86.50% along the measured length of line 83 being equivalent to the aircraft wheel-base. Nose landing gear strut pressure is measured at 1,156 psi, which relates to 22,113 lb. supported by the nose landing gear strut. The total weight of the aircraft as calculated by LBUM is 163,800 lb. The 22,113 lb. supported by the nose landing gear strut is equivalent to 13.50% of the total aircraft weight. The remaining 86.50% of the aircraft weight can only be supported by the remaining combined main landing gear struts, thus must be computed to equal 141,687 lb.

Point 73 represents the center of nose gear 9. The length of line 83, from point 73 to point 81, does not change. The distance from point 73 to the datum line 3 is known and does not change, thus the location of CG 5 is relative to the datum line, and can be determined.

Determination of aircraft CG can be accomplished by identifying the computed weight of the combined main landing gear by subtracting the measured weight supported by the nose landing gear from the LBUM calculated total weight of the aircraft, to further determine the percentage of the combined main landing gear weight as a percentage of the total aircraft weight, where:
_{Cal}W_{Total}==Calculated Weight of the Total aircraft
_{Cal}W_{Total}=163,800 lb. (calculated via LBUM)
_{M}W_{N}=Measured Weight supported by the Nose landing gear strut
_{M}W_{N}=22,113 lb. (a measured weight)
_{Comp}W_{L&RM}=Computed Weight supported by the Left & Right Main landing gear struts
_{Comp}W_{L&RM}=_{C}W_{Total}−_{M}W_{N}
_{Comp}W_{L&RM}=163,800 lb.-22,113 lb.
_{Comp}W_{L&RM}=141,687 lb.
CG=Center of Gravity, identified as a % of the distance aft, from the nose landing gear to the main landing gear
CG=_{D}W_{L&RM}÷_{C}W_{TOTAL} %
CG=141,687 lb.÷163,800 lb. %
CG=86.50%

This determined CG location is a percentage of the distance aft from the location of nose landing gear, to the location of the main landing gear.

An alternate method for the determination of aircraft CG can be accomplished by measuring the weight supported by the nose landing gear and determining that percentage of weight supported by the nose gear to the total aircraft weight as determined by the LBUM. The percentage of weight supported by nose landing gear is applied as an equivalent percentage of the distance between the nose landing gear and the main landing gear to determine the location of the aircraft CG, where:
_{Cal}W_{Total}=Calculated Weight of the Total aircraft
_{Cal}W_{Total}=163,800 lb. (calculated via LBUM)
_{M}W_{N}=Measured Weight supported by the Nose landing gear strut
_{M}W_{N}=22,113 lb. (a measured weight)
CG=Center of Gravity, identified as a % of the distance forward from the main landing gear
CG=_{M}W_{N}÷_{C}W_{TOTAL} %
CG=22,113 lb.÷163,800 lb. %
CG=13.50%

To make this CG determination, which is based on aircraft wheel-base dimension more practical for use by an airline operator the CG determination may be converted into a value of % MAC which is a corresponding value in reference to a point associated a percentage value located aft of the leading edge of the aircraft's Mean Aerodynamic Chord. A simple look-up table is created which relates % wheel-base to that of % MAC. Additionally a simple look-up table is created which relates % wheel-base to that of a corresponding value in relation to an aircraft station number. An additional look-up table is obtained from a range of pressure measurements taken from the nose landing gear in relation to measured aircraft CO, during an optional and initial calibration of the system, while the aircraft is resting on weighing measuring scales. The scales are used in the initial calibration process, but are not needed in subsequent aircraft CG determinations by reference to the created look-up table. The look-up table can be updated while the aircraft is in operation, by extrapolating from initial calibration data to the weight distribution ratios experienced at the time a CG determination is desired. There are multiple variations of using different combinations of measured landing gear supported weight in relation to a calculated total aircraft weight, to identify aircraft CG. For example, the weight supported by each main landing gear can be measured and combined, then subtracted from the calculated total aircraft weight to determine the remainder weight supported by the single nose landing gear, as an alternate method to determine the aircraft CG.

Referring now to FIG. 7, there is shown a block diagram illustrating the apparatus and software of the invention. Nose landing gear pressure-temperature sensor 27 supplies landing gear strut pressure-temperature data inputs into CG computer 19. Additionally, nose landing gear strain gauge sensors 29 supply data inputs corresponding to landing gear strut axle deflection into CG computer 19. Cockpit display-keypad 20 allows for LBUM data to be manually input, by aircraft pilots, into Computer 19. Inclinometer 25 monitors any changes in the aircraft hull angle in relation to horizontal, and supply aircraft angle data as additional inputs to Computer 19. Computer 19 is equipped with an internal clock and calendar to document the time and date of stored data. A typical source of the LBUM weight data is the airline dispatcher. Computer 19 has multiple software packages which include:
Program “A” a software routine for monitoring nose landing gear strut pressure and temperature to further measure the weight supported by the nose landing gear strut.
Program “B” a software sub-routine to Program “A” for monitoring nose landing gear strut pressure, to further correct pressure distortions related to temperature and landing gear strut seal friction errors. The complete disclosure of U.S. Pat. Nos. 5,214,586 and 5,548,517 are incorporated herein by reference.
Program “C” a software routine for determining the weight supported by the combined main landing gear struts by subtracting the measured weight supported by the nose landing gear strut (via strut pressure) from the calculated total weight of the aircraft (via LBUM), as compared to the measured weight supported by the nose landing gear strut, to further determine the aircraft CG.
Program “D” a software routine for monitoring variations in the nose gear axle deflection, as related to applied weight supported; from strain gauge sensors attached to the nose landing gear axle to measure the weight supported by the nose landing gear strut, to further determine the aircraft CG. This routine can be used as an alternative to Program “A”.
Program “E” a software routine utilizing look-up tables to convert the determined aircraft CG in relation to a percentage of the distance between the nose landing gear to the main landing gear; to an equivalent value as measured as % MAC, and/or aircraft Station Number.
Program “F” a software routine for identifying aircraft incline that is different from horizontal, then correcting the measured and calculated CG of the un-level aircraft, to that of a level aircraft.

In operation, the aircraft is at a location at the airport preparing for its next flight. Typically if the aircraft is taking on passengers and baggage, the aircraft is located at a gate. The aircraft takes on weight in the form of passengers, baggage, cargo and/or fuel.

When the aircraft is ready, it departs the gate, taxis to the runway and then takes off down the runway and begins flight. Most, if not all, commercial aircraft are approved for flight by way of being dispatched. To be approved or dispatched for flight, the takeoff weight of the aircraft is determined to ensure the weight is within the operational limits of the aircraft. To determine aircraft CG the methods herein described above are used. However, to determine the total aircraft weight, another method independent of physically weighing the aircraft is used. An example of a method to determine total aircraft weight (the LBUM process) is to use approved weight assumptions assigned for passengers and their baggage. In addition to the assumptions regarding passenger weight and baggage weight, the empty weight of the aircraft is known from past measurements on scales. The weight of fuel is determined from measuring the volume of fuel added to the aircraft during refueling and converting that volume into pounds. The CG of the aircraft just before being dispatched and for takeoff can be monitored and determined using the techniques described above. Once the total weight and aircraft CG determinations are made, the aircraft is then dispatched, and approved for flight.

Additionally, as an exemplary embodiment of the invention has been disclosed and discussed, it will be understood that other applications of the invention are possible and that the embodiment disclosed may be subject to various changes, modifications, and substitutions without necessarily departing from the spirit and scope of the invention.

1. A method of determining a Center of Gravity of an aircraft on the ground and having plural main landing gear struts and a nose landing gear strut, each of the main and nose landing gear struts supporting a respective amount of aircraft weight when the aircraft is on the ground, comprising the steps of:
a) determining a total weight of the aircraft, independent of measuring the aircraft weight;
b) measuring a weight supported by the nose landing gear strut;
C) comparing the measured nose strut weight to the total aircraft weight as a percentage;
d) identifying the aircraft Center of Gravity as a percentage of the distance between the nose and main landing gear struts.

2. The method of claim 1 wherein the step of measuring a weight supported by the nose landing gear strut further comprises the step of measuring an internal pressure within the nose landing gear strut.

3. The method of claim 1 wherein the nose landing gear strut has an axle, wherein the step of measuring a weight supported by the nose landing gear strut further comprises the step of measuring a deflection in the nose landing gear strut axle.

4. The method of claim 1 wherein the step of measuring a weight supported by the nose landing gear strut further comprises the step of measuring rotation of a linkage on the nose landing gear strut.

5. The method of claim 1 wherein the step of measuring a weight supported by the nose landing gear strut further comprises the step of placing a scale beneath the nose landing gear strut tires.

6. The method of claim 1 wherein the step of determining the total weight of the aircraft further comprises the step of using a load build-up process of applying designated weight values for items such as fuel, passengers and baggage, to the empty measured weight of the aircraft.

7. The method of claim 6 wherein the aircraft is flown under a Regulatory Authority, wherein the load build-up weight values for the passengers and baggage are approved by the Regulatory Authority.

8. The method of claim 1 further comprising the step of dispatching the aircraft for a flight using the determined aircraft Center of Gravity and the independently determined aircraft weight.

9. The method of claim 1 wherein the step of determining the aircraft Center of Gravity further comprises the step of determining the aircraft Center of Gravity as a distance measured from the aircraft datum line.

10. The method of claim 1 wherein the step of determining the aircraft Center of Gravity further comprises the step of determining the aircraft Center of Gravity as a % MAC.

11. The method of claim 1 wherein the step of determining the aircraft Center of Gravity further comprises the step of determining the aircraft Center of Gravity as a distance relative to an aircraft station number.

12. A method of determining a Center of Gravity of an aircraft on the ground and having plural main landing gear struts and a nose landing gear strut, each of the main and nose landing gear struts supporting a respective amount of aircraft weight when the aircraft is on the ground, comprising the steps of:
a) determining a total weight of the aircraft, independent of measuring the aircraft weight, the aircraft weight comprising the operating empty weight of the aircraft, the weight of fuel on board, the weight of payload items on board including the weight of passengers on board, and the weight of baggage on board, the weights of the passengers and the baggage being determined by Regulatory Authority approved designated weights;
b) measuring a weight supported by the nose landing gear strut;
c) determining the weight supported by the combined main landing gear struts by removing the measured nose strut weight from and the independently determined total aircraft weight;
d) comparing the determined combined main landing gear strut weight to the total aircraft weight to identify the aircraft Center of Gravity as a percentage of the distance between the nose and main landing gear struts.

13. The method of claim 12 wherein the step of measuring a weight supported by the nose landing gear strut further comprises the step of measuring an internal pressure within the nose landing gear strut.

14. The method of claim 12 wherein the nose landing gear strut has an axle, wherein the step of measuring a weight supported by the nose landing gear strut further comprises the step of measuring a deflection in the nose landing gear strut axle.

15. The method of claim 12 wherein the step of measuring a weight supported by the nose landing gear strut further comprises the step of measuring rotation of a linkage on the nose landing gear strut.

16. The method of claim 12 wherein the step of measuring a weight supported by the nose landing gear strut further comprises the step of placing a scale beneath the nose landing gear strut tires.

17. The method of claim 12 wherein the step of determining the total weight of the aircraft further comprises the step of using a load build-up process of applying designated weight values for items such as fuel, passengers and baggage, to the empty measured weight of the aircraft.

18. The method of claim 12 wherein the aircraft is flown under a Regulatory Authority, wherein the load build-up weight values for the passengers and baggage are approved by the Regulatory Authority.

19. The method of claim 12 further comprising the step of dispatching the aircraft for a flight using the determined aircraft Center of Gravity and the independently determined aircraft weight.

20. The method of claim 12 wherein the step of determining the aircraft Center of Gravity further comprises the step of determining the aircraft Center of Gravity as a distance measured from an aircraft datum line.

21. The method of claim 12 wherein the step of determining the aircraft Center of Gravity further comprises the step of determining the aircraft Center of Gravity as a % MAC.

22. The method of claim 12 wherein the step of determining the aircraft Center of Gravity further comprises the step of determining the aircraft Center of Gravity as a distance relative to an aircraft station number.

23. A method of determining a Center of Gravity of an aircraft on the ground and having plural main landing gear struts and a nose landing gear strut, each of the main and nose landing gear struts supporting a respective aircraft weight when the aircraft is on the ground, comprising the steps of:
a) determining a total weight of the aircraft, independent of measuring the weight supported by the nose landing gear strut;
b) measuring a combined weight supported by the plural main landing gear struts;
c) comparing the measured weight supported by the plural main landing gear struts to the total weight of the aircraft to determine the aircraft Center of Gravity.
